(19) United States
(12) Patent Application Publication
(10) Pub. No.: US 2023/0297326 A1
(43) Pub. Date: Sep. 21, 2023

(54) MANAGEMENT SYSTEM

(71) Applicant: HONDA MOTOR CO., LTD., Tokyo (JP)

(72) Inventors: Takashi Miyata, Tokyo (JP); Taiki Yamada, Tokyo (JP); Tomoaki Hagihara, Tokyo (JP)

(21) Appl. No.: 18/121,655

(22) Filed: Mar. 15, 2023

(30) Foreign Application Priority Data
Mar. 17, 2022 (JP) 2022-042464

(51) Int. Cl. G06F 3/16

(52) U.S. Cl. CPC G06F 3/165

(57) ABSTRACT

A management system includes a storage medium storing computer-readable instructions and one or more processors connected to the storage medium, the processor executing the computer-readable instructions to manage information about a model for use in a system that recommends content to a user by inputting location information and preference information of the user to the model and decide on a degree to which the preference information is reflected for each piece of the content when the recommended content is selected in the model.

### CROSS-REFERENCE TO RELATED APPLICATION

Priority is claimed on Japanese Patent Application No. 2022-042464, filed Mar. 17, 2022, the content of which is incorporated herein by reference.

### BACKGROUND

### Field of the Invention

The present invention relates to a management system.

### Description of Related Art

In the related art, an invention of a device for learning preference information of a user using a portable information terminal in accordance with a time period and a place in which the user performs an action is disclosed (Japanese Patent No. 3838014).

### SUMMARY

In Japanese Patent No. 3838014, a process of learning preference information of a user for each piece of content is not disclosed. Thus, in the related art, it may be difficult to appropriately use preferences of a user depending on content.

The present invention has been made in consideration of such circumstances and an objective of the present invention is to provide a management system capable of appropriately using preferences of a user depending on content.

A management system according to the present invention adopts the following configurations.

(1): According to an aspect of the present invention, there is provided a management system for managing information about a model for use in a system that recommends content to a user by inputting location information and preference information of the user to the model, the management system including: a reflection degree decision unit configured to decide on a degree to which the preference information is reflected for each piece of the content when the recommended content is selected in the model.

(2): According to another aspect of the present invention, there is provided a management system for managing information about a model for use in a system that recommends content to a user by inputting location information and preference information of the user to the model, the management system including: an acquisition unit configured to acquire first evaluation information of the user when the content is recommended and played at a first location and second evaluation information of the user when the same content is played at a second location; and an update unit configured to update the preference information on the basis of a comparison between the first evaluation information and the second evaluation information.

(3): According to yet another aspect of the present invention, there is provided a management system for managing information about a model for use in a system that recommends content to a user by inputting time period information and preference information to the model, the management system including: a reflection degree decision unit configured to decide on a degree to which the preference information is reflected for each piece of the content when the recommended content is selected in the model.

(4): According to yet another aspect of the present invention, there is provided a management system for managing information about a model for use in a system that recommends content to a user by inputting time period information and preference information to the model, the management system including: an acquisition unit configured to acquire first evaluation information of the user when the content is recommended and played in a first time period and second evaluation information of the user when the same content is played in a second time period; and an update unit configured to update the preference information on the basis of a comparison between the first evaluation information and the second evaluation information.

(5): In the above-described aspect (2) or (4), the update unit updates the preference information on the basis of the comparison between the first evaluation information and the second evaluation information with respect to the content for which the first evaluation information is higher than a first reference.

(6): In the above-described aspect (2), (4), or (5), the management system further includes a reflection degree decision unit configured to decide on the degree to which the preference information is reflected for each piece of the content when the recommended content is selected in the model, wherein the reflection degree decision unit lowers the degree to which the preference information is reflected for the content when the second evaluation information is lower than a second reference.

(7): In the above-described aspect (2) and (4) to (6), the management system further includes a reflection degree decision unit configured to decide on the degree to which the preference information is reflected for each piece of the content when the recommended content is selected in the model, wherein the reflection degree decision unit raises the degree to which the preference information is reflected for the content when the second evaluation information is higher than a third reference.

According to the aspects (1) to (7), it is possible to appropriately use preferences of a user depending on content.

### BRIEF DESCRIPTION OF THE DRAWINGS

FIG. 1 is a configuration diagram of a content provision system to which a management system is applied.

FIG. 2 is a diagram showing an example of content of user information.

FIG. 3 is a diagram showing an example of content of map information.

FIG. 4 is a diagram showing an overview of a flow of a process related to sound recommendation.

FIG. 5 is a configuration diagram of the management system.

FIG. 6 is a diagram showing an example of information included in a sound provision history.

FIG. 7 is a diagram showing an example of evaluation information.

FIG. 8 is a flowchart showing an example of a flow of a process executed by the management system.

### DESCRIPTION OF EMBODIMENTS

Hereinafter, embodiments of a management system of the present invention will be described with reference to the drawings.

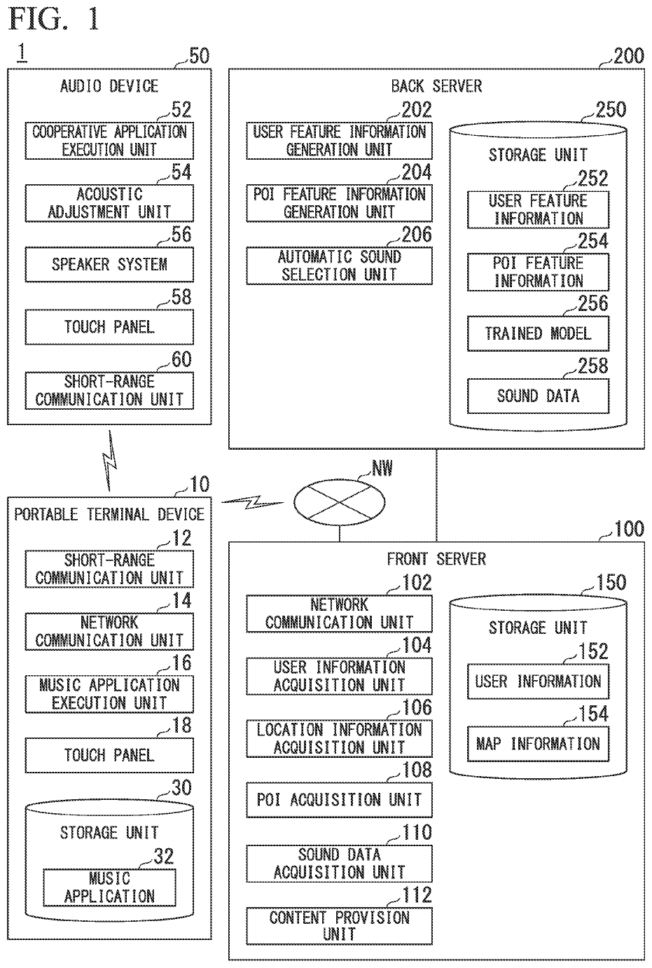

FIG. 1 is a configuration diagram of a content provision system 1 to which the management system is applied. The content provision system 1 is a system that provides content to an occupant in a mobile object. The content is, for example, sounds. The sounds are music and may include environmental sounds and the like as well as an artist's song, musical performance, or program-played music. Although it is assumed that the content is a sound in the following description, the content may be video content with an image or the like. Examples of the mobile object include a vehicle with a space for an occupant to stay (a vehicle with four or three wheels, micromobility, or the like), a watercraft, an aircraft, or a two-wheeled vehicle. In the case of the two-wheeled vehicle, an audio device provided in a helmet may function as the terminal device.

The content provision system 1 includes, for example, a music application 32 operating in the portable terminal device 10 and a front server 100. The front server 100 is an example of a content provision device. The portable terminal device 10 and an audio device 50 are examples of devices used by a user.

### [Portable Terminal Device]

The terminal device 10 is, for example, a portable computer device having a communication function, an input/output function, and an application execution function of a processor such as a smartphone or a tablet terminal. The terminal device 10 includes, for example, a short-range communication unit 12, a network communication unit 14, a music application execution unit 16, and a touch panel 18.

The short-range communication unit 12 performs wireless or wired communication with a short-range communication unit 60 of an audio device 50 on the basis of a communication standard such as Bluetooth (registered trademark), Wi-Fi, or Universal Serial Bus (USB).

The network communication unit 14 communicates with a front server 100 via a network NW. The network NW includes a radio base station, an access point, the Internet, a provider terminal, a wide area network (WAN), and the like.

The music application execution unit 16 functions when a processor such as a central processing unit (CPU) executes a music application 32 stored in a storage unit 30. The music application execution unit 16 controls each part of the terminal device 10 in accordance with an input manipulation of a user performed on the touch panel 18. For example, the music application 32 is installed on the terminal device 10 in advance from a server device of the application provider.

### [Audio Device]

The audio device 50 is installed on a mobile object (or may be installed on a helmet as described above). The audio device 50 includes, for example, a cooperative application execution unit 52, an acoustic adjustment unit 54, a speaker system 56, a touch panel 58, and the short-range communication unit 60.

The cooperative application execution unit 52 functions by a processor such as a CPU executing a cooperative application (not shown) stored in the storage unit. The cooperative application execution unit 52 controls each part of the audio device 50 in cooperation with the music application execution unit 16 in response to the user's input operation performed on the touch panel 58.

The acoustic adjustment unit 54 controls the speaker system 56. The speaker system 56 includes, for example, a plurality of speakers. The acoustic adjustment unit 54 may localize a sound image at any location by adjusting a volume of each of the plurality of speakers.

As described above, the short-range communication unit 60 communicates with the short-range communication unit 12 of the portable terminal device 10 wirelessly or by wire.

### [Front Server]

The front server 100 includes, for example, a network communication unit 102, a user information acquisition unit 104, a location information acquisition unit 106, a point of interest (POI) acquisition unit 108, a sound data acquisition unit 110, a content provision unit 112, and a storage unit 150. Components other than the network communication unit 102 and the storage unit 150 are implemented, for example, by a hardware processor such as a CPU executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be prestored in a storage device (a storage device including a non-transitory storage medium) such as a hard disk drive (HDD) or a flash memory or may be stored in a removable storage medium (a non-transitory storage medium) such as a digital video disc (DVD) or a compact disc-read-only memory (CD-ROM) and installed when the storage medium is mounted in a drive device. The storage unit 150 stores information such as user information 152 or map information 154.

The network communication unit 102 communicates with the terminal device 10 via the network NW. Although communication between the front server 100 and a back server 200 may also be performed via the same network NW, communication may be performed via a dedicated line, a local area network (LAN), a virtual private network (VPN), or the like.

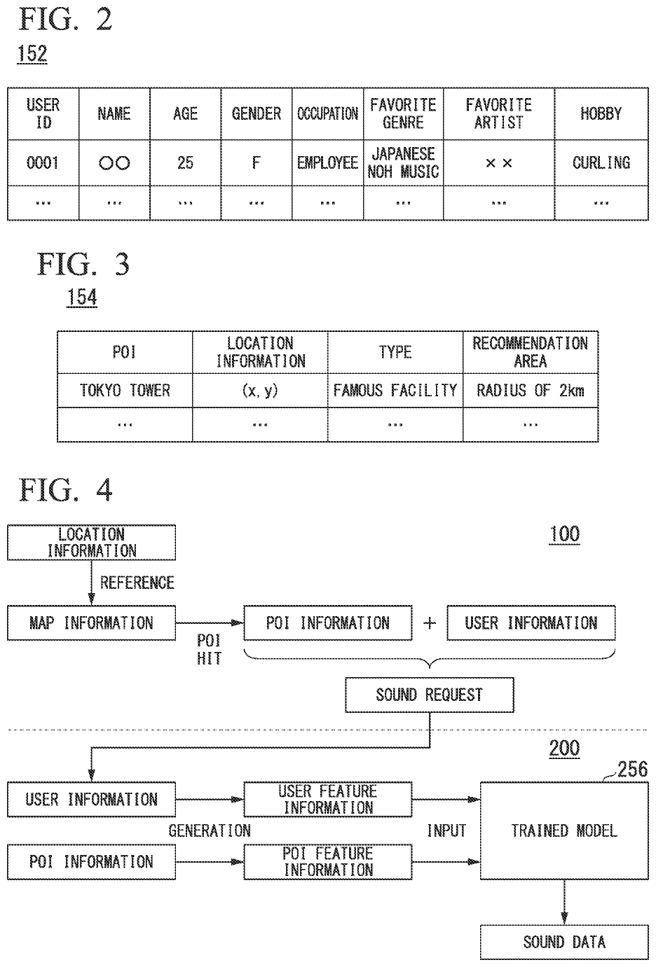

The user information acquisition unit 104 acquires information of a user (user information) of the terminal device 10 and registers the acquired user information in the user information 152. FIG. 2 is a diagram showing an example of content of the user information 152. The user information 152 includes, for example, a name, age, gender, occupation, favorite music genre, preferred artist, hobby, and the like, and user feature information derived therefrom. The user information acquisition unit 104 appropriately updates the user information 152 in accordance with an input manipulation from the user.

The location information acquisition unit 106 acquires the location information of the user (or the mobile object). The location information of the user (or the mobile object) is measured, for example, by a location measurement device (a Global Positioning System (GPS) receiver or the like (not shown)) provided in the mobile object on which the audio device 50 is installed and transmitted to the front server 100 via the audio device 50 and the portable terminal device 10. Alternatively, the user's location information may be measured by a location measurement device (not shown) provided in the portable terminal device 10 and transmitted to the front server 100.

The POI acquisition unit 108 acquires a POI in which the user enters a sound recommendation area (hereinafter referred to as “recommendation area”) (hereinafter referred to as “POI hit”) with reference to the map information 154 using the user's location information. Entering the sound recommendation area is an example in which the user has approached a POI (point). FIG. 3 is a diagram showing an example of content of the map information 154. The map information 154 includes a plurality of pieces of POI information and information of a recommendation area corresponding to each of the plurality of pieces of POI information. The POI information includes, for example, information such as POI location information (latitude and longitude) and a type of POI associated with a POI (for example, a famous facility, a scenic spot, or the like).

The POI included in the map information 154 may be changed as appropriate. For example, a POI where a limited-time event is held may be included in the map information 154 only during a period when the event is held. Also, information associated with the POI may be changed as appropriate. For example, when a light show is held at a POI included in the map information 154, for example, a tourist spot, the recommendation area may be expanded only during a time period when the light show is held.

The map information 154 may further include road structure information. When the map information 154 includes a road structure, a recommendation area may be set by a distance from passing the road to reaching the POI. Although the POI included in the map information 154 is considered to be a sound recommendation target, a POI that is not a sound recommendation target may be included in the map information 154. In this case, a flag indicating a sound recommendation target is associated with the POI.

When a certain POI has been hit, the sound data acquisition unit 110 transmits a sound request to the back server 200. The sound request includes the user's user information (the user's name may be deleted from the viewpoint of personal information protection, the age may be changed to “30s” or the like, and the occupation may also be changed from detailed information to a granularity such as “employee”) and POI information indicating the hit POI (which may be POI identification information). When a plurality of POIs have been hit, the sound data acquisition unit 110 includes POI information of any of the plurality of POIs in the sound request. The POI information included in the sound request will be described below.

As will be described below, when the sound request is acquired, the back server 200 automatically selects a sound matching the user and the POI, acquires sound data of a sound from sound data 258, for example, by selecting the sound in a streaming format, and transmits the acquired sound data to the front server 100. The sound data acquisition unit 110 acquires sound data transmitted by the back server 200 and automatically recommended. The sound data acquired by the sound data acquisition unit 110 is automatically recommended on the basis of the user information and the hit POI information when the user has entered the recommendation area.

When the user has entered the recommendation area, the content provision unit 112 transmits the sound data acquired by the sound data acquisition unit 110 to the portable terminal device 10 and causes the portable terminal device 10 to be able to play the sound data. The portable terminal device 10 transmits sound data to the audio device 50 and causes the sound data to be played by the speaker system 56. Also, a function of holding the sound data 258 and providing the sound data 258 as a source for providing the sound data may be in the front server 100 or may be in another server device.

The portable terminal device 10 or the audio device 50 proposes the playback of the sound recommended by the proximity of the POI to the user. For example, the portable terminal device 10 or the audio device 50 displays an image or outputs a sound to ask the user whether or not the proposed sound is desired to be played and plays the recommended sound when the user replies with acceptance by touch operation or voice.

### [Back Server]

The back server 200 includes, for example, a user feature information generation unit 202, a POI feature information generation unit 204, an automatic sound selection unit 206, and a storage unit 250. Functional units other than the storage unit 250 are implemented, for example, by a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (a non-transitory storage medium) such as a DVD or a CD-ROM and installed when the storage medium is mounted in a drive device. The storage unit 250 stores information such as user feature information 252, POI feature information 254, a trained model 256, and the sound data 258.

The user feature information generation unit 202 generates user feature information in a format such as a vector on the basis of user information included in the sound request. In preparation for second and subsequent sound requests related to the same user, the generated user feature information may be stored as the user feature information 252 in the storage unit 250.

The POI feature information generation unit 204 generates POI feature information in the form of a vector or the like on the basis of the POI information included in the sound request. In preparation for the second and subsequent sound requests related to the same POI, the generated POI feature information may be stored as the user feature information 252 in the storage unit 250.

Also, one or both of a function of generating user feature information from user information and a function of generating POI feature information from POI feature information may be functions of the front server 100. In this case, the sound request may include, for example, the user feature information and the POI feature information.

By inputting the user feature information and POI feature information corresponding to the sound request to the trained model 256, the automatic sound selection unit 206 extracts sound data of a sound that matches the user and the POI that the user approaches and passes from the sound data 258 and automatically recommends the extracted sound data. The automatic sound selection unit 206 transmits the automatically recommended sound data to the front server 100. The sound data acquisition unit 110 of the front server 100 acquires the sound data automatically recommended by the automatic sound selection unit 206.

The trained model 256 is trained using information obtained from the feedback experiment results in advance as correct answer data. The trained model 256 is trained to select a sound actually highly evaluated in that situation when, for example, “a 30-something man passes by the Tokyo Tower.” The feedback experiment is, for example, a collection of user feedback such as a high evaluation, a low evaluation, and re-playback of sound provision through the music application 32.

FIG. 4 is a diagram showing an overview of a flow of a process related to sound recommendation. When the front server 100 acquires the user's location information transmitted by the portable terminal device 10 or the audio device 50, the front server 100 determines whether or not the POI has been hit with reference to the acquired location information from the map information. When the POI has been hit, the user information of the user who has transmitted the location information and the POI information of the hit POI are included in the sound request and transmitted to the back server 200.

The back server 200 generates user feature information on the basis of the user information corresponding to the transmitted sound request and inputs the generated user feature information to the trained model 256. The back server 200 generates POI feature information on the basis of the POI information corresponding to the transmitted sound request and inputs the generated POI feature information to the trained model 256. The back server 200 extracts output data of the trained model 256 from the sound data 258 as sound data of a sound that matches the user and the POI that the user approaches and passes by.

### [Management System]

Hereinafter, the management system will be described. The management system updates (decides on) a degree to which the user feature information is reflected in selection of sound data or updates the user feature information by retraining a user feature information generation process, a POI feature information generation process, and an information-learned model 256 (a combination thereof corresponds to a “model” in the claims) on the basis of a history of sounds provided by the content provision system 1. Each component of the management system may be located on the front server 100, the back server 200, or a computer device different therefrom.

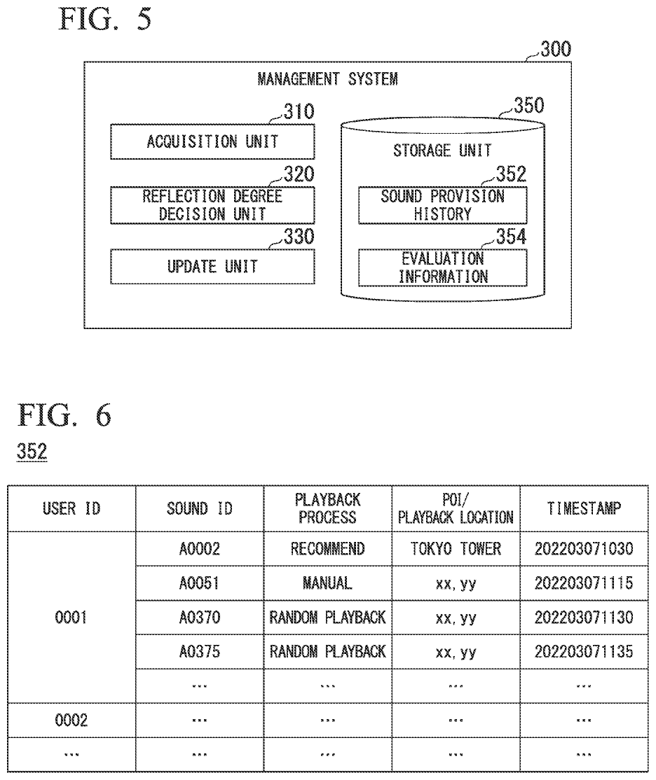

FIG. 5 is a configuration diagram of a management system 300. The management system 300 includes, for example, an acquisition unit 310, a reflection degree decision unit 320, an update unit 330, and a storage unit 350. Components other than the storage unit 350 are implemented, for example, by a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be prestored in a storage device (a storage device including a non-transitory storage medium) such as an HDD or a flash memory or may be stored in a removable storage medium (a non-transitory storage medium) such as a DVD or a CD-ROM and installed when the storage medium is mounted in a drive device. The storage unit 350 stores information such as a sound provision history 352 and evaluation information 354.

The acquisition unit 310 acquires the history 352 of sounds provided by the content provision system 1 and the evaluation information 354 of users therefor and causes the storage unit 350 to store the history 352 and the evaluation information 354. FIG. 6 is a diagram showing an example of information included in the sound provision history 352.

The sound provision history 352 is, for example, information in which a sound ID, information indicating a process in which a sound is generated (whether a sound has been played by sound recommendation or whether a sound has been played in another method (manual selection of the user, random playback, or the like)), a POI of the case of the sound recommendation), and a timestamp indicating a playback time are associated with a user ID.

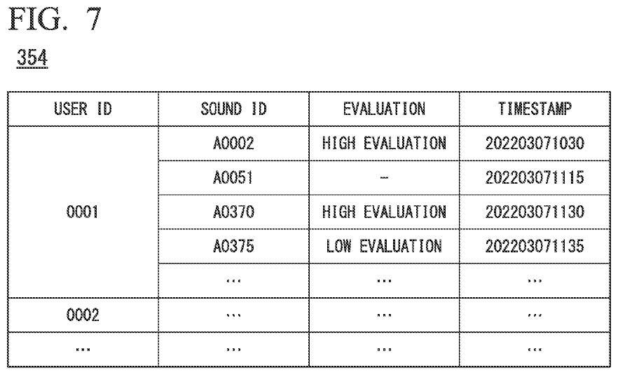

The evaluation information 354 is obtained by collecting evaluations (for example, there are two evaluations. An evaluation process may be performed at more levels) input by the user on the interface screen provided by the touch panel 18 or the touch panel 58 when the sound is played (during or after playback). FIG. 7 is a diagram showing an example of the evaluation information 354. The evaluation information is, for example, information in which a sound ID, an evaluation of the sound of the sound ID, and a timestamp are associated with the user ID.

The reflection degree decision unit 320 decides on a degree to which the user feature information (an example of preference information) is reflected for each sound when a recommended sound is selected in a model with reference to the sound provision history 352 and the evaluation information 354. The reflection degree decision unit 320 retrains the trained model 256 so that the degree to which the user feature information is reflected in a sound is lowered when second evaluation information is lower than a second reference (for example, the second evaluation information is lowly evaluated) with reference to, for example, first evaluation information of the user when the sound is played by the sound recommendation at a first POI and second evaluation information of the user when the same sound is played at a location different from the first POI (a second location). At this time, the second evaluation information is, for example, evaluation information of the user when the same sound is played at the location different from the first POI (the second location) regardless of the recommendation. Also, the second evaluation information may include evaluation information of the user at the time of playback according to the recommendation. Also, when the second evaluation information is higher than a third reference (for example, the second evaluation information is highly evaluated), the reflection degree decision unit retrains the trained model 256 to increase a degree to which the user feature information is reflected in the sound. The reflection degree decision unit 320 may perform such processing only for a sound for which the first evaluation information is higher than the first reference (for example, the first evaluation information is highly evaluated). Here, the trained model 256 is generated for each sound, outputs a “recommendation degree of recommendation to the user” as an output value, and the back server 200 recommends a sound with the highest recommendation degree. In this case, it is only necessary for the reflection degree decision unit 320 to retrain the trained model 256 for the sound.

Although a case where the evaluation of a sound is expressed by two types of a high evaluation and a low evaluation has been described above, the second reference and the third reference may be arbitrarily determined if the second reference is equal to or lower than the third reference when the evaluation is expressed at more levels.

The update unit 330 updates the user feature information on the basis of a comparison between the first evaluation information and the second evaluation information. The update unit 330 updates the user feature information on the basis of the comparison between the first evaluation information and the second evaluation information with respect to a sound for which the first evaluation information is higher than the first reference (for example, the first evaluation information is highly evaluated). More specifically, the update unit 330 updates the user feature information of the user so that, for example, it is determined that a sound for which not only the first evaluation information but also the second evaluation information are highly evaluated is a favorite sound of a user (i.e., the processing content of the user feature information generation unit 202 is modified to have a high degree to which it is determined that the user likes the sound). A “degree to which it is determined that the user likes the sound” is calculated, for example, in the middle layer of the trained model 256, and the trained model 256 is configured to determine whether or not to finally select a sound by the activation function. The update unit 330 updates the user feature information by performing backpropagation including a derivation model of the user feature information so that the output value of the intermediate layer is high. On the other hand, if there is a sound for which the first evaluation information is highly evaluated and the second evaluation information is lowly evaluated, it does not necessarily mean that the user likes the sound itself, i.e., the update unit 330 estimates that the first evaluation information is highly evaluated together with the POI and does not update the user feature information.

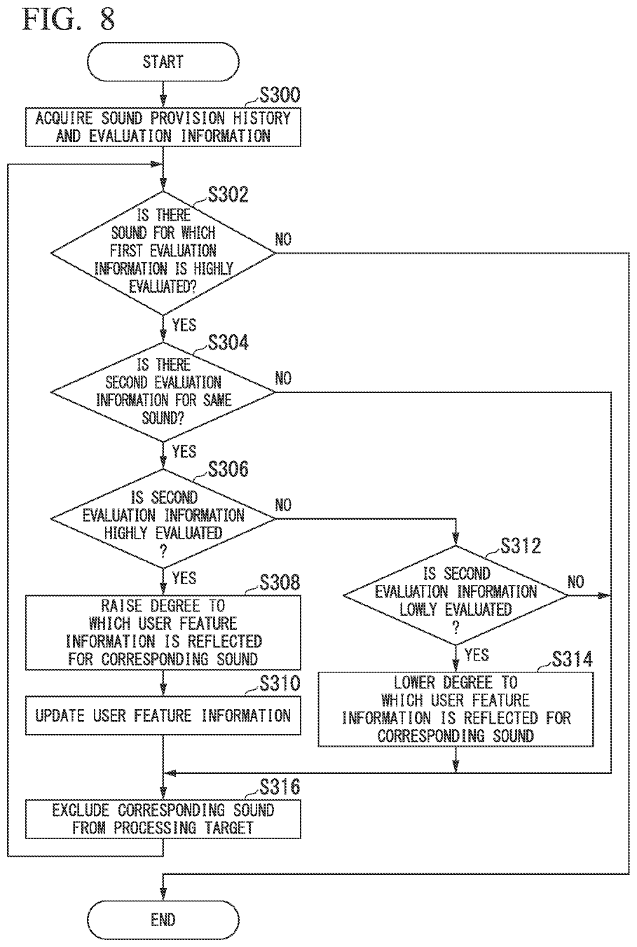

FIG. 8 is a flowchart showing an example of a flow of a process executed by the management system 300. First, the acquisition unit 310 acquires the sound provision history 352 and the evaluation information 354 (step S300).

Subsequently, the reflection degree decision unit 320 or the update unit 330 determines whether or not there is a sound for which the first evaluation information is highly evaluated, i.e., whether or not there is a sound played by the recommendation and having a high evaluation (step S302). When there is a sound for which the first evaluation information is highly evaluated, the reflection degree decision unit 320 or the update unit 330 determines whether or not there is second evaluation information, i.e., evaluation information at the time of playback at a different location, for the same sound (step S304).

When the second evaluation information is present for the same sound, the reflection degree decision unit 320 or the update unit 330 determines whether or not the second evaluation information is highly evaluated (step S306). When the second evaluation information is highly evaluated, the reflection degree decision unit 320 increases the degree to which the user feature information is reflected for the sound (step S308) and the update unit 330 updates the user feature information (step S310).

When the second evaluation information is not highly evaluated, the reflection degree decision unit 320 or the update unit 330 determines whether or not the second evaluation information is lowly evaluated (step S312). When the second evaluation information is lowly evaluated, the reflection degree decision unit 320 lowers the degree to which the user feature information is reflected for the sound (step S314).

When the processing of steps S304 to S314 is completed, the reflection degree decision unit 320 or the update unit 330 excludes the sound from a processing target (step S316) and returns the process to step S302. When a sound with high evaluation of the first evaluation information is not found in step S302, the process of the present flowchart ends.

According to the above-described embodiment, the preferences of users who depend on the content (sound) can be appropriately used.

### [Application to Time Period]

In the above-described embodiment, a configuration in which a “POI” is replaced with a “time period” may be adopted. That is, the content provision system may recommend content (sounds) by inputting user feature information and time period information to a trained model. For this, a management system may acquire first evaluation information of a user when a sound is recommended and played in a first time period and second evaluation information of the user when the same sound is played in a second time period, retrain a trained model so that a degree to which user feature information is reflected for the sound is raised and update the user feature information of the user so that it is determined that the sound is a favorite sound of the user when the second evaluation information is highly evaluated as in the above-described embodiment, and retrain the trained model so that a degree to which user feature information is reflected for the sound is lowered when the second evaluation information is lowly evaluated. Similarly, in such a configuration, the preferences of users who depend on the content (sounds) can be appropriately used.

### [Application to Combination of POI and Time Period]

Furthermore, in the above-described embodiment, the content provision system may recommend content (sounds) by inputting user feature information, POI feature information, and time period information to the trained model. That is, the content provision system may be, for example, a system for “recommending a sound suitable for the Tokyo Tower in the evening by reflecting a user's preference.” In addition to (or in place of) executing the above-described process individually for the POI or the time period, the management system may perform a process based on a combination of the POI and the time period. For example, the management system may acquire first evaluation information of a user when a sound is recommended and played in a first time period at a first POI and second evaluation information of the user when the same sound is played in a second time period at a second POI and perform the above-described process.

Although embodiments of the present invention have been described in detail above with reference to the drawings, specific configurations are not limited to the embodiments and other designs and the like may also be included without departing from the scope of the present invention.

What is claimed is:

1. A management system comprising:
a storage medium storing computer-readable instructions; and
one or more processors connected to the storage medium, the processor executing the computer-readable instructions to:
manage information about a model for use in a system that recommends content to a user by inputting location information and preference information of the user to the model, and
decide on a degree to which the preference information is reflected for each piece of the content when the recommended content is selected in the model.

2. A management system comprising:
a storage medium storing computer-readable instructions; and
one or more processors connected to the storage medium, the processor executing the computer-readable instructions to:
manage information about a model for use in a system that recommends content to a user by inputting location information and preference information of the user to the model,
acquire first evaluation information of the user when the content is recommended and played at a first location and second evaluation information of the user when the same content is played at a second location, and
update the preference information on the basis of a comparison between the first evaluation information and the second evaluation information.

3. A management system comprising:
a storage medium storing computer-readable instructions; and
one or more processors connected to the storage medium, the processor executing the computer-readable instructions to:
manage information about a model for use in a system that recommends content to a user by inputting time period information and preference information to the model, and
decide on a degree to which the preference information is reflected for each piece of the content when the recommended content is selected in the model.

4. A management system comprising:
a storage medium storing computer-readable instructions; and
one or more processors connected to the storage medium, the processor executing the computer-readable instructions to:
manage information about a model for use in a system that recommends content to a user by inputting time period information and preference information to the model,
acquire first evaluation information of the user when the content is recommended and played in a first time period and second evaluation information of the user when the same content is played in a second time period, and
update the preference information on the basis of a comparison between the first evaluation information and the second evaluation information.

5. The management system according to claim 2,
wherein the processor updates the preference information on the basis of the comparison between the first evaluation information and the second evaluation information with respect to the content for which the first evaluation information is higher than a first reference.

6. The management system according to claim 2,
wherein the processor decides on the degree to which the preference information is reflected for each piece of the content when the recommended content is selected in the model, and
wherein the processor lowers the degree to which the preference information is reflected for the content when the second evaluation information is lower than a second reference.

7. The management system according to claim 2,
wherein the processor decides on the degree to which the preference information is reflected for each piece of the content when the recommended content is selected in the model, and
wherein the processor raises the degree to which the preference information is reflected for the content when the second evaluation information is higher than a third reference.

8. The management system according to claim 4,
wherein the processor updates the preference information on the basis of the comparison between the first evaluation information and the second evaluation information with respect to the content for which the first evaluation information is higher than a first reference.

9. The management system according to claim 4,
wherein the processor decides on the degree to which the preference information is reflected for each piece of the content when the recommended content is selected in the model, and
wherein the processor lowers the degree to which the preference information is reflected for the content when the second evaluation information is lower than a second reference.

10. The management system according to claim 4,
wherein the processor decides on the degree to which the preference information is reflected for each piece of the content when the recommended content is selected in the model, and
wherein the processor raises the degree to which the preference information is reflected for the content when the second evaluation information is higher than a third reference.
